(19) United States
(12) Patent Application Publication
(10) Pub. No.: US 2013/0289464 A1
(43) Pub. Date: Oct. 31, 2013

(54) APPARATUS AND METHOD FOR THERAPEUTIC SPINAL TREATMENT

(71) Applicants: Yoram Felix Guenniche, Zur Yigal (IL); Gal Demer, Tel Aviv (IL)

(72) Inventors: Yoram Felix Guenniche, Zur Yigal (IL); Gal Demer, Tel Aviv (IL)

(73) Assignee: KINETIC MEDICUS LTD, RAMAT HASHARON (IL)

(21) Appl. No.: 13/989,822

(22) PCT Filed: Jan. 18, 2012
(86) PCT No.: PCT/IB12/50242

§ 371 Date: May 28, 2013

Related U.S. Application Data
(60) Provisional application No. 61/433,638, filed on Jan. 18, 2011.

(51) Int. Cl. A61H 1/00

(52) U.S. Cl. CPC A61H 1/006
USPC 602/36

(57) ABSTRACT

An apparatus and method for applying therapeutic spinal treatment to a patient has an anchor that connects to a first portion of the patients body above the cervical spine area. The anchor substantially fixes the location of that portion in the apparatus and a movable interface is provided in the apparatus with which the patient is adapted to interact with an operative part of his body. Movement of the movable interface together with the operative part of the patient's body imposes upon at least a second portion of the patients body that is below the first portion movement at the spine.

### TECHNICAL FIELD

Embodiments of the invention relate to an apparatus and a method for therapeutic spinal treatment in orthopedics.

### BACKGROUND

Physical pain or distress (caused by, for example, injury to the spinal cord) is a malady afflicting large numbers of people. A common approach to try to provide relief from such pain is to apply traction to the suffering person.

Many therapeutic devices exist that apply such traction to the human body. Such devices may selectively adjust for example abnormal articulations of the spinal cord in order to assure full and free range of motion of afflicted areas of the spinal cord and thereby free impinged nerves that may cause the pain.

Korean patent publication No. 20090055662 describes a spinal correction device that uses the weight of a person being treated in the device in order to urge the traction to be applied to that person. The device has a chair and an actuator coupled to a part of the chair in order to move the chair up and down.

Korean patent publication No. 20090088728 describes an apparatus for aerobic exercise of spine during vertical repetitive traction that utilizes the weight of the person who exercises for the traction. The apparatus has for example a bottom support that is installed at both sides of a treadmill for exercising the person during treatment.

Korean patent publication No. 20050011600 describes a portable spine treatment apparatus that enables a traction force to act on a spinal column while suppressing a pain or injury to muscles or soft tissues of ligaments in a vertebral portion. Such traction is performed in a direction opposite to gravity to reduce a weight load applied to the vertebral portion.

U.S. Pat. No. 3,868,951 describes an orthopedic traction device which consists of a frame having upstanding arms attached to a base member portion, upon which a patient may recline. Tension force is transmitted to the patient from the lever arm through a cable and pulley system connected to a head harness and the tension force is transmitted to the spinal column and may be reacted by shoulder pads mounted on extensible arms pivotally mounted on the frame.

U.S. Pat. No. 3,759,255 describes an apparatus for use in providing spinal or cervical traction in order to alleviate pain and reduce degenerative conditions of the spine. The apparatus has a harness that fits around the body, a hand operable winch associated with the harness, and a hook attached to the winch for engagement with a hook secured in an elevated position such as a door lintel. In this apparatus the user can raise himself clear of the floor by operating the winch handle and a gear ratio of the winch is such that only a relatively light pressure on the handle is sufficient to operate it.

French patent No. 2686260 describes an apparatus that makes it possible to perform, both at home and when travelling, and without the aid of a third person, gymnastic exercises intended to increase the suppleness (flexibility) and muscle tone of the cervical or lumber regions. The apparatus has a bracket which is fastened over an open or closed door and movable equipment which provides the relaxation traction (pulling action) on the cervical region or the lumber region, by means of weights which the user can add or remove in order to modify the tension.

U.S. Pat. No. 7,357,777 describes a spinal traction/decompression device suitable for home or clinical treatment of lumbar and cervical spine pathology. The traction apparatus has a substantially flat upper body support that is moveable with respect to a fixed base. The upper body support is adapted to receive the upper torso of an individual leaning forward in a prone position while kneeling on a knee cushion. A pelvis/hip restraining portion holds the individual's lower torso in position with respect to the fixed base when the upper body support is moved.

### SUMMARY OF THE PRESENT INVENTION

The following embodiments and aspects thereof are described, and illustrated in conjunction with systems, tools and methods which are meant to be exemplary and illustrative, not limiting in scope.

One aspect of the present invention is directed to an apparatus for applying therapeutic spinal treatment to a patient, the apparatus having an axis and comprising an anchor adapted to connect to a first portion of the patient's body that is located axially above the cervical spine area in order to substantially fix the location of that first portion in the apparatus, and a movable interface with which the patient is adapted to interact with an operative part of his body, wherein the applying of the therapeutic spinal treatment includes movement of the movable interface together with the operative part of the patient's body in order to impose upon at least a second portion of the patient's body that is below the first portion movement at the spine.

Another aspect of the present invention involves a method for applying therapeutic spinal treatment to a patient comprising the steps of providing an apparatus comprising an anchor that is adapted to substantially fix in the apparatus the location of a first portion of the patient's body that is located axially above the cervical spine area, and a movable interface with which the patient is adapted to interact with an operative part of his body, and having the movable interface move together with the operative part of the patient's body in order to impose upon at least a second portion of the patient's body that is below the first portion movement at the spine

A still further aspect of the present invention is a method of spine. rehabilitation for a patient, comprising choosing a starting position of the patient in the treatment process, the starting position including one of a standing position and a sitting position; stabilizing the patient by immobilizing one of (i) the head of the patient and (ii) the head and the axilla of the patient; choosing a spine load from between unloading and loading; choosing a motion module by choosing which movement the patient is to perform and a range of the movement; and activating the patient with at least one of passive, assisted active, active and resisted movements

In an embodiment, the present invention is adapted to improve vertebral mobility and reduce spinal pains in a secure and functional apparatus. In some embodiments the invention relates to a traction/compression apparatus (comprising a head retainer, a bilateral axillary support, a hand support, a mobile seat and a mobile standing plate) and a number of detachable modules permitting selective movements of a Closed Kinetic Chain Exercise (CKCE) nature (the standing plate, the seat and a steering wheel).

Optionally, the seat, the standing plate and the steering wheel enable variable motions around each body axes of movements. The traction/compression starting position can be standing, relying or sitting. The traction/compression may optionally be applied to the cervical spine through the head anchor or to the thoracic and lumbar spine through the head anchor and the axillary supports. On each position the patient may be able to achieve a variety of controlled passive, active or even resisted motions, enabled optionally by the mobile seat, standing plate or steering wheel. The traction/compression is increased by lowering/rising the body in relation to the fixed head.

In an embodiment, improvement of vertebral motion may be obtained by applying movements during head fixation and then traction/compression. The body may be optimally supported at the: hands, axilla, lumbar and feet. Furthermore in some embodiments the apparatus may be easily adjusted for patient's height as every support may be height adjustable. The traction/compression safety may be achieved by a specific head anchor that automatically unlocks if weight applied suddenly rises to a predefined threshold. In some embodiments, the invention may be called functional as the traction/compression is done in functional/ADL (activity of daily living) positions and uses functional movements to further enhance the spinal traction/compression.

In addition to the exemplary aspects and embodiments described above, further aspects and embodiments will become apparent by reference to the figures and by study of the following detailed descriptions.

### BRIEF DESCRIPTION OF THE FIGURES

Exemplary embodiments are illustrated in the referenced figures. The embodiments and figures disclosed herein are to be considered illustrative, rather than restrictive. The invention, however, both as to organization and method of operation, together with objects, features, and advantages thereof, may best be understood by reference to the following detailed description when read with the accompanying figures:

FIG. 1 schematically shows a perspective top view of an apparatus for therapeutic spinal treatment in accordance with an embodiment of the present invention;

FIG. 2 schematically shows the apparatus of FIG. 1 with a patient being treated;

FIG. 3 is a section of FIG. 1 that schematically shows an embodiment of an anchor of the apparatus;

FIGS. 4 and 5 schematically show front views of the anchor in various states;

FIG. 6 schematically shows an embodiment of a base of the apparatus;

FIG. 7 schematically shows a perspective top view of another embodiment of the apparatus for therapeutic spinal treatment with a patient being treated;

FIG. 8 schematically shows a perspective top view of yet another embodiment of the apparatus for therapeutic spinal treatment with a patient being treated;

FIG. 9 schematically shows an embodiment of a base of the apparatus of FIG. 8;

FIGS. 10a and 10b schematically show an embodiment of an anchor that includes a chin retaining portion, a zygomatic bone retaining portion and a head retaining portion, the head retaining portion retaining a back of the head and a top of the head, the patient shown in FIG. 10a but not in FIG. 10b.

For simplicity and clarity of illustration, elements shown in the figures have not necessarily been drawn to scale. For example, the dimensions of some of the elements may be exaggerated relative to other elements for clarity. Furthermore, where considered appropriate, reference numerals may be repeated within the figures to indicate similar elements.

### DETAILED DESCRIPTION OF THE INVENTION

Various embodiments of an apparatus for applying therapeutic spinal treatment to a patient that are schematically displayed in the figures are based on therapeutic principles that facilitate spine rehabilitation. In some embodiments, the patient is treated in functional positions such as standing or sitting in which he may encounter pain or may alternatively be clear of his painful symptoms.

In some cases, the apparatus may be used to apply traction (or unloading) to a patient in order to apply tension upon the patient's spine; and in some cases, the apparatus may be used to apply compression (or loading) upon the patient's spine. Such loading or unloading may for example urge open facet joints, may elongate tissues, and/or may stimulate the erector muscles of the spine to work.

In accordance with some embodiments, such loading or unloading may be applied in a so-called “reversed” way that is characterized by fixing the head of the patient within the apparatus and then allowing selective movements at a lower or other portion of the apparatus upon which the patient for example stands or sits. These selective movements are typically of a Closed Kinetic Chain Exercise (CKCE) nature where physical exercise is performed for example to the arm or leg of the patient while respectively the hand or foot of the patient remains in constant contact with the surface upon which it is placed. These CKCE exercises typically force movements in proximal body joints as the end of the limb is unable to move during treatment. Also in some embodiments these selective movements may be adapted to apply loading or unloading upon the patient. Such “reversed” loading or unloading has been found by the inventors to relieve the apprehension of the patient being treated which thereby results in the patient's spinal muscles being more relaxed during treatment to allow more mobility and an improved therapeutic effect.

By applying selective movements of CKCE nature to the patient during such loading or unloading it has been found by the inventors that it is possible in some cases to urge open hypo-mobile or locked facet joints. When the head is fixed from movement, spinal muscles have to work in a reversed origin-insertion way during exercises, which further improves mobility and reduces pain from the patient. The applying of selective movements of CKCE nature during unloading or loading while implementing head fixation in the apparatus has been found to improve segmental functioning (differentiation or integration). During such selective movements, different parts of the spine are asked to move while the head is fixed, thus increasing overall spinal abilities. Such movements may for example be passive (i.e. urged by the apparatus or by the therapist), active (i.e. urged by the patient), or resisted (i.e. slowed by for example friction so that the patient must apply force in order to accomplish the movement).

In contrast to prior art therapeutic devices, for example for the spine, which do not limit all or nearly all of the degrees of freedom of movement of the head (or for that matter other parts of the body) of the patient while the patient is in the device, the apparatus and method of the present invention may restrict movement of a first portion, such as the head, of the patient's body along three perpendicular axes. Each axis comprises two directions (up, down, forward, backward, left, right). The first portion may be restricted in 5 or 6 directions (excluding “up” in some embodiments). The first portion may also be restrained rotationally along each of the three axes. This may be accomplished by the anchor of the present invention, which may prevent the head from rotating or moving side to side or front to back or down (or up in some embodiments), in contrast to the prior art, in which a cable may hold the head and in some cases prevent in moving down, but the head can still rotate or move to the side or front or back. In further contrast to the prior art therapeutic devices, in which tension on the spine may be unloaded by stabilizing the proximal spine and distracting the distal end of the spine where the head is (i.e. immobilizing the torso and moving the head), the present invention may decompress or unload the spine by immobilizing the head and gradually lowering the remainder of the body located below the head including the distal end of the spine. In addition, while certain prior art devices may unload, the present invention may load (compress) and unload (decompress) the spine. Spine compression may stimulate the erector muscles of the spine to work. Applied with selective movements, it may also pry open hypo-mobile or locked facet joints. In further contrast to the prior art, in which the spine may be unloaded from the head only, in the present invention, the spine may be unloaded from the head only and may be unloaded from the head and axilla. In still further contrast to prior art therapeutic devices, in which a single mode of treatment may be utilized, in the present invention may provide multiple modes of treatment, for example traction, head immobilization, exercising, that may be utilized. In still further contrast to the prior art therapeutic devices, in which headgear is used and which may be risky if the apparatus fails, the apparatus and method of the present invention may utilize a head immobilization device that may incorporate a security or safety mechanism in which the head immobilization device may become rotatable and/or movable (e.g. downward), and/or the chin and any of the retaining portions of the anchor may detach from the anchor, upon application by the anchor of a compression or tension force above a threshold level upon the patient.

The principles and functions of the present invention (which may include functional positioning, reversed traction or compression, reversed origin-insertion muscular activation, segmental differentiation/integration, core strengthening, proprioceptive awareness and manual techniques) may make the methods and apparatus of the present invention therapeutically beneficial for the treatment of various conditions including post surgery conditions; disk bulging and nerve root symptoms; facets joint symptoms; segmental instability (spondylolysis and spondylolisthesis) and subluxation; spondylosis; spina bifida and ankylosing spondylitis; idiopathic back pain; whiplash and other post-traumatic symptoms; mal-alignment and posture; and other conditions requiring spine rehabilitation.

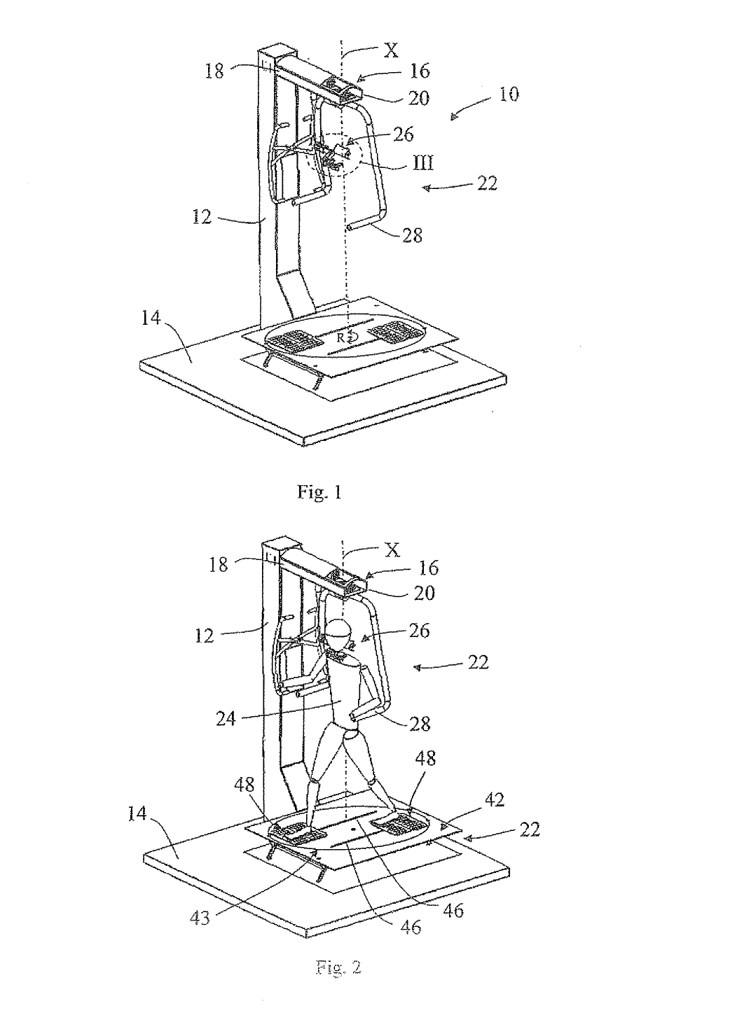

Attention is first drawn to FIGS. 1 and 2. An apparatus 10 in accordance with an embodiment of the present invention has a post 12 that extends upwardly alongside an axis X of the apparatus 10 from an optional lower floor 14 of the apparatus 10. An upper beam 16 of the apparatus 10 extends parallel to the floor 14 between first and second sides 18, 20 and is attached at its first side 18 to the post 12. The beam 16 is adapted to be axially moveable at its first side 18 along the post 12 in order to allow axial adjustment of its height in relation to the floor 14 and the apparatus 10 has an engagement means 22 that suspends downwards towards the floor 14 from the second side 20 of the beam 16 and is adapted to engage a patient 24 being treated in the apparatus 10.

The axis X of the apparatus 10 defines opposing axial upward and downward direction and it should be noted that the directional terms appearing throughout the specification and claims, e.g. “forward”, “rear”, “up”, “down” etc., (and derivatives thereof) are for illustrative purposes only, and are not intended to limit the scope of the appended claims. In addition it is noted that the directional terms “down”, “below” and “lower” (and derivatives thereof) define identical directions.

In an embodiment, the engagement means 22 includes an anchor 26 and a pair of atm rests 28. The arm rests 28 are adapted to provide support to the arms of the patient 24 as he is being treated in the apparatus 10 and the anchor 26 is adapted to be attached to an upper first portion of the patient's body just above the cervical spine area in order to substantially negate all possible movement from that first portion of the patient's body and thereby substantially fix that portion of the patient's body in a substantially fixed location in the apparatus 10.

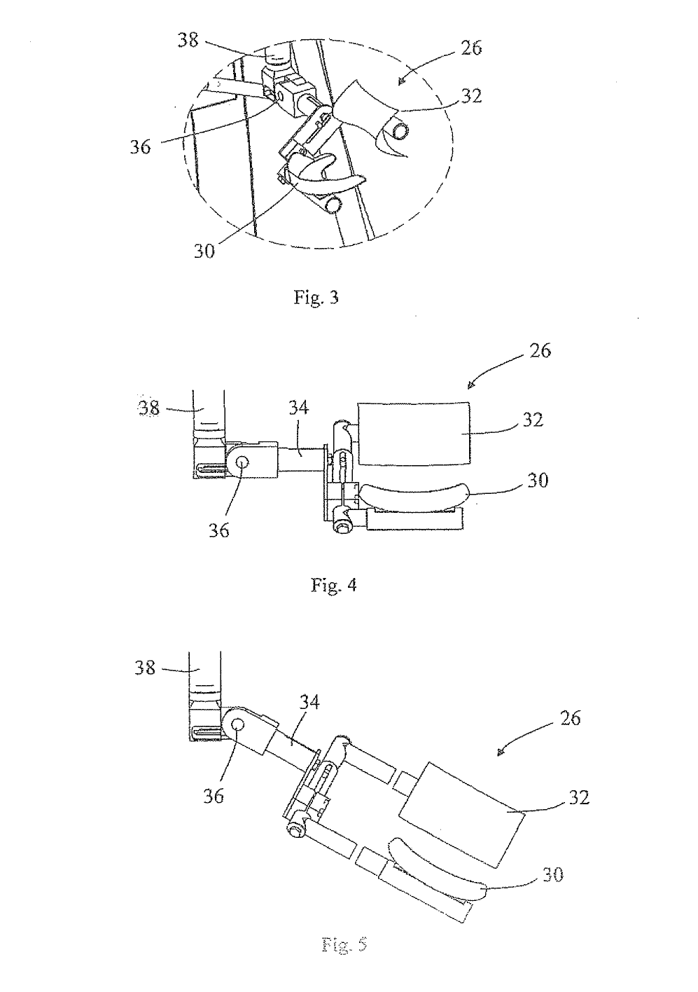

Attention is now drawn to FIGS. 3 to 5. In an embodiment, the anchor 26 has a chin retaining portion 30 (a first anchor portion) and a back-of-the-head retaining portion 32 (a second anchor portion) that are adapted to be moveable towards or away from each other (i.e. so as to adjust a distance between the chin retaining portion and the back-of-the-head retaining portion) in order to adjust to the dimensions of the patient's head; and the anchor 26 when fixed to the patient's head is adapted to substantially negate all movement from the head. “Movement”, in the previous sentence, may include movement in either direction along each of the three axes, which axes may be perpendicular to one another. As can be seen from FIG. 3, chin retaining portion 30 may be curved (for example substantially semi-circular or substantially horseshoe-shaped) so as to further restrict side to side movement of the patient's head. The chin retaining portion 30 may restrain the front of the head and the back-of-the-head retaining portion 32 may restrain the back of the head. The anchor 26 has a rod 34 that extends sideways to attach at a hinge 36 to a shaft 38 of the engagement means 22 that suspends down from the second side 20 of the beam 16, and initial adjustment of the anchor 26 to the height of the patient 24 being treated may be performed by axially moving the beam 16 in order to axially adjust the height of the anchor 26 to the region of the patient's body to which the anchor 26 is required to attach.

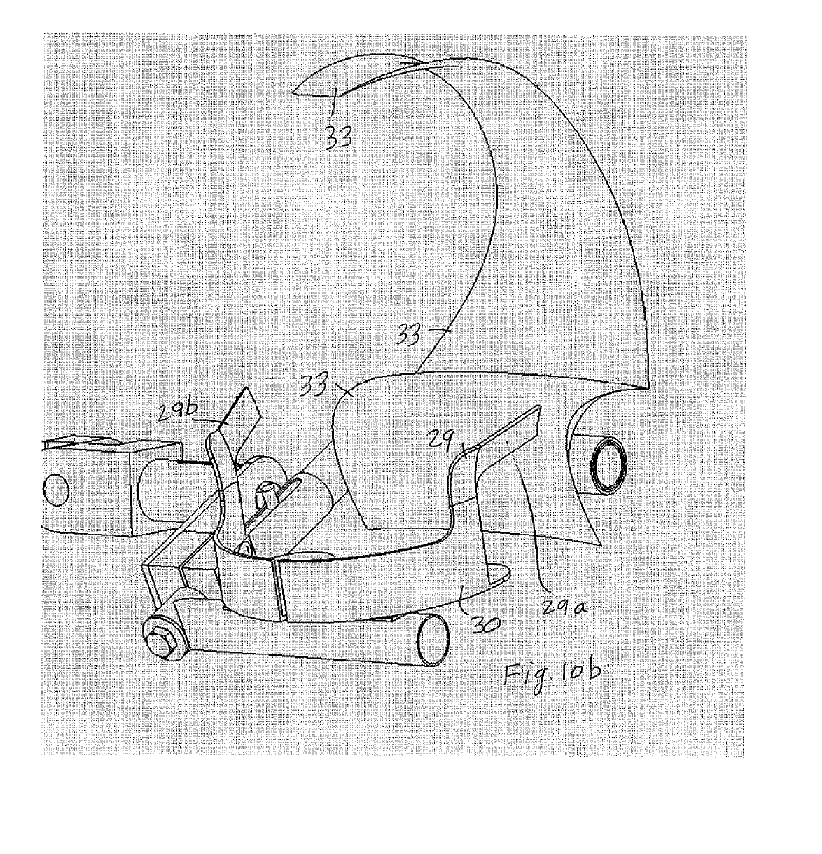

As shown in FIGS. 10a-b, in some embodiments, the anchor 26 includes a chin retaining portion 30 and a rear-and-top-of-the-head retaining portion 33. The head retaining portion may be a single unit that retains a back of the head and a top of the head. As also shown in FIGS. 10a-b, the anchor 26 may further include a zygomatic bone retaining portion 29 that includes left and right zygomatic bone retaining portions 29a, 29b adaptable to be movable so as to adjust a distance between the left and right zygomatic bone retaining portions 29a, 29b. The zygomatic bone retaining portion 29 may restrain side to side and rotational movement of the head 99 of the patient, the head in this instance representing the first portion (or the upper first portion) of the patient's body.

Attention is specifically drawn to FIGS. 4 and 5. In an embodiment, the engagement means 22 of the apparatus 10 has a safety mechanism that is adapted to free the anchor 26 from its fixed location in the apparatus 10 in the case that an emergency occurs in which the patient 24 is exposed at the anchor 26 for example to forces above a pre-determined threshold level that may harm him. This safety mechanism may be implemented by providing a safety pin (not shown) that engages the hinge 36 in order to fix the rod 34 at a desired angle in relation to the shaft 38 (as seen in FIG. 4), wherein the pin is adapted to deform or break under a certain magnitude of moment that is applied thereupon when for example the anchor 26 is suddenly urged axially to apply upon the patient 24 a compression or tension force that exceeds a certain pre-defined level.

In the event that the pin fails for example while applying tension to the patient 24 then the hinge 36 which is now free to rotate allows the anchor 26 to rotate clockwise and downwards (as can be seen in FIG. 5) in order to alleviate the undesired tension from the patient 24. In an embodiment, an additional aspect of the safety mechanism may be provided by the ability of the chin and neck retaining portions 30, 32 to be detached from the anchor 26 during such rotation of the anchor 26 as can be seen in FIG. 5.

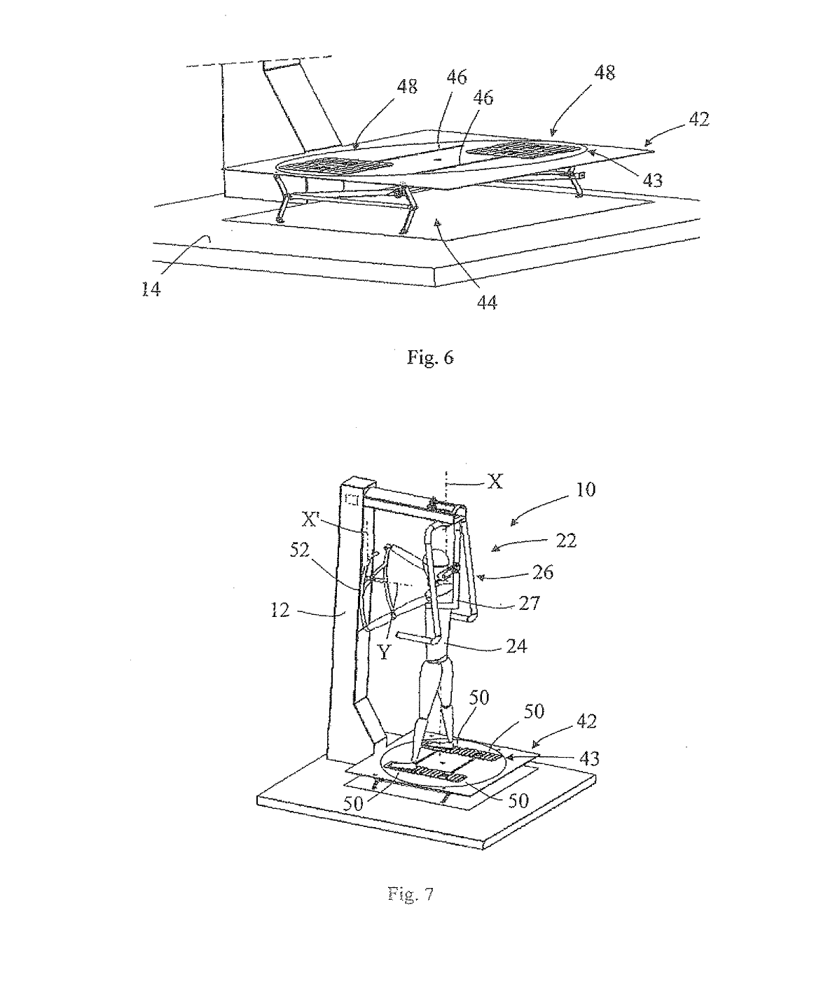

Attention is now drawn to FIG. 6. In an embodiment, the apparatus 10 has a base 42 that is adapted to support the weight of the patient 24 and in this example the patient 24 is adapted to stand on the base 42 with operative parts of his body which in this example are both his feet. The base 42 has a lifting means 44 that is adapted to axially lift or lower the base 42 in relation to the floor 14 and the patient 24 when standing on the base 42 is adapted to be lifted or lowered together therewith. It is noted that during treatment of the patient 24 the base 42 (or any interface support means of the base such as the stool that will be described later on below in this description) must always be in contact with the patient 24 and should not for example be lowered to such an extent that leaves the patient 24 detached from contact with it and hanging on the anchor 26.

Attention is now additionally drawn back to FIG. 2. In an embodiment, the base 42 has two parallel tracks 46 and two interface support means in the form of movable pad means 48 that are each associated with a respective one of the tracks 46 for sliding engagement therewith. Optionally, the base 42 has also a central interface standing plate in the form of a movable disk 43 that is adapted to rotate about the axis X and upon the disk 43 the tracks 46 and the pad means 48 are formed and located. The patient 24 when standing on the base 42 may interact with the pad means 48 by standing with his feet on the pad means 48 and the patient 24 with his feet may urge the pad means 48 to slide in their tracks 46 and/or urge the disk 43 to rotate.

In order to be treated in the apparatus 10, the patient 24 may first be guided by the therapist to stand on the base 42 and then if required the height of the beam 16 is axially adjusted in order to position the anchor 26 adjacent the portion of the patient's body which the therapist would like to fix in location. In the example that is shown, the anchor 26 is fixed to the patient's head above the cervical spine area of the patient 24 and once this has been completed the therapeutic treatment of the spine of the patient 24 may begin.

In embodiments of the apparatus loading or unloading may be imposed upon the patient in various ways. In some embodiments, the patient by the assistance of simple means upon which he for example stands may be urged to apply the so-called “reversed” unloading or loading of the spine. In one embodiment for example, the patient by simply standing on interface support means similar to the movable pad means 48 that are located on a base such as simply the floor, may spread his feet and lower his body to thereby impose unloading upon the spine; and by for example initially standing with his feet spread apart upon interface support means similar to the pad means 48 and then gathering his feet together may lift his body to thereby impose loading upon the spine.

In other embodiments, by lowering or lifting the base 42, the therapist may apply the so-called “reversed” unloading or loading of the spine of the patient 24 that is respectively characterized by tension or compression that is applied upon the spine. As already noted herein above, the so-called “reversed” unloading or loading has been found by the inventors to relieve the apprehension of the patient 24 being treated which results in the patient's spinal muscles being more relaxed during treatment to allow more mobility and an improved therapeutic effect.

In an embodiment, once applying a certain amount of axial loading or unloading, the therapist may guide the patient 24 to commence selective movements of CKCE nature and in the example that is currently discussed this selective movement may be accomplished by the patient 24 moving his feet to slide the movable interface pad means 48 in their tracks 46 and/or by move his feet in order to urge rotation of the interface disk 43 which results in a selective movement that includes twisting of the patient's spine generally about the axis X. In an embodiment, the interface pad means 48 and/or disk 43 may be urged to move by the apparatus 10 to thereby impose upon the patient 24 a so called passive selective movement. In other embodiments, the patient 24 may freely move the interface pad means 48 and/or disk 43, or may be required to apply a certain amount of force upon the interface pad means 48 and/or disk 43 in order to overcome for example friction that may be implemented between the pad means 48 and the tracks 46.

In accordance with various embodiments of the present invention, different types of movement of the interface pad means 48 and/or other interface means on the base 42 of the apparatus 10 may be performed. In some examples, both interface pad means 48 may be urged by the patient or the apparatus to slide in a similar direction to thereby urge both feet of the patient to be moved in a similar direction, the interface pad means 48 may be urged to slide in opposing directions in order to facilitate spreading or gathering of the patient's legs, rotation of the interface disk 43 and thereby the interface pad means 48 therewith may be urged to occur with or without sliding movement of the interface pad means 48, (etc.).

Attention is now drawn to FIG. 7. In an embodiment, the patient 24 may be positioned in the apparatus 10 facing sideways such as towards the post 12 of the apparatus 10. Similarly to the previously discussed apparatus 10, the patient 24 by the assistance of simple interface means upon which he for example stands and/or by lowering or lifting of the base 42 may be urged to undergo “reversed” unloading or loading of the spine and in this example it is seen that each interface pad means 48 may be divided into two sub-pads 50 that are adapted to allow the patient 24 when positioned in this way to perform selective movements of his legs by interactively placing his feet upon two sub pads 50 of a given pad means 48 and then spreading and gathering his feet with or without also urging the disk 43 to rotate.

The apparatus 10 may include in an embodiment also additional interface means for facilitating selective movements to the patient 24 such as an interface wheel 52 which the patient may interact or engage with an operative part of his body which in this example are his hands in order to perform selective movements of upper parts of the body that may include twisting of the spine. The wheel 52 may be coupled to the post 12 and may be urged to rotate about an axis X′ that extends along the post and is parallel to the axis X and/or also about an axis Y that is generally perpendicular to the axis X in order to thereby cause twisting of the spine generally about the axis Y. Also the engagement means 22 may include in an embodiment in addition to the anchor 26 also a secondary anchor 27 that is adapted to attach to the axilla or armpit of the patient in order to substantially fix a secondary location of the patient's body and thereby alleviate tension from the cervical spine where the anchor 26 is attached.

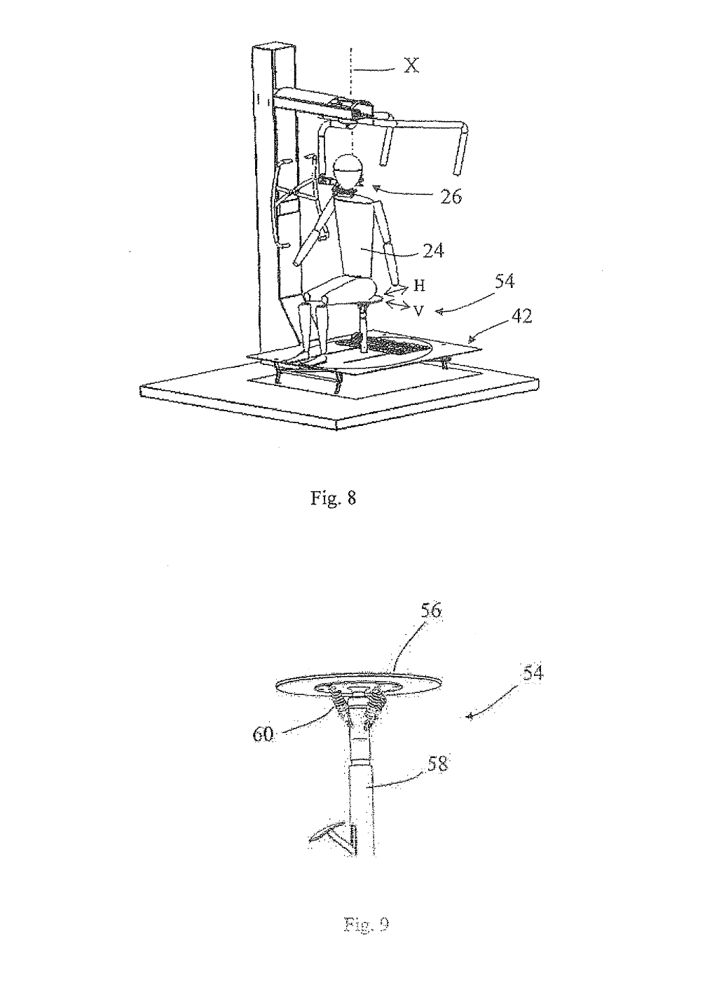

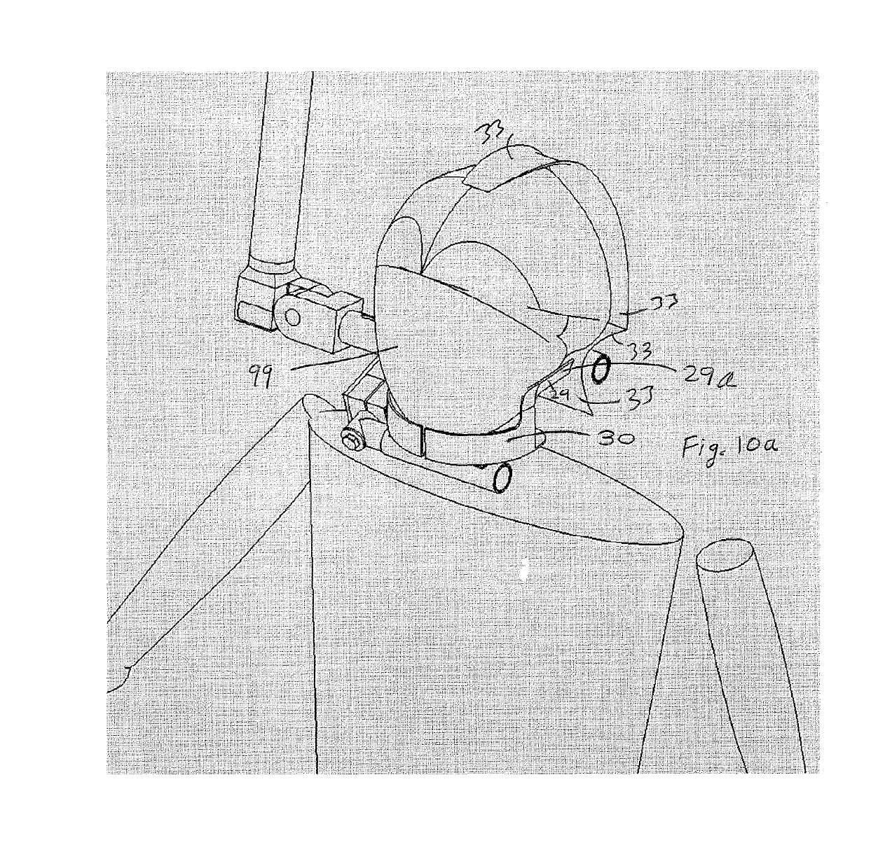

Attention is now drawn to FIG. 8. In an embodiment, the base 42 of the apparatus 10 may include an interface support means in the form of a stool 54 upon which the patient may sit with an operative part of his body which in this example is his buttocks. The stool 54 is adapted to support at least a portion of the weight of the patient 24 during treatment and the patient 24 in this example is treated seated in the apparatus 10 with a portion of his body at a location above the cervical spine area being substantially fixed in location by the anchor 26. The stool 54 of the apparatus 10 has a circular plate 56 that is placed at an upper side of a pole 58 and the plate 56 may be adapted to perform selective movements in relation to the pole 58 that include translation along directions parallel to the floor such as the direction indicated by the arrows H and V.

Attention is additionally drawn to FIG. 9. In an embodiment, the plate 56 may also be tilted in relation to the pole 58. Optionally, a plurality of springs 60 may be coupled to the pole 58 and plate 56 in order to urge the plate 56 to a normal position in relation to the pole 58 in which the plate 56 is perpendicular to the pole 58, and the patient 24 after for example being initially loaded or unloaded may perform (or may be urged to perform) selective movements in the area of his lower spine by tilting the plate 56 of the interface stool 54 against the force of the springs 60.

A high level description of a method of spine rehabilitation of the present invention may include a step of choosing the starting position of the patient in the treatment process. The starting position may be standing or sitting. Another step of this method may be stabilizing the patient, for example by immobilizing the head alone or immobilizing the head and the axilla of the patient. A further step may include choosing the spine load, for example reducing pression felt (unloading) or increasing pression felt (loading). In a further step, the motion module may be chosen. This involves choosing which movement the patient is to perform and selecting the range of the chosen movement. The method then may involve a step of activating the patient with at least one of passive, assisted active, active and resisted movements. These movements may include one of these types followed by another (or more) of these types. The movements may be isometric, concentric or eccentric. They can be applied to a full or restricted range.

At any stage the therapist can join in and add manual techniques to the spine in order to further enhance treatment. Generally, the patient may be treated in functional positions. The method of the present invention may also involve proprioceptive activation. The proprioception sense may be challenged and sharpened by spatial location during exercising and axial alteration (loading and unloading of the spine) and a specific motion module.

In the description and claims of the present application, each of the verbs, “comprise” “include” and “have”, and conjugates thereof, are used to indicate that the object or objects of the verb are not necessarily a complete listing of members, components, elements or parts of the subject or subjects of the verb.

Although the present embodiments have been described to a certain degree of particularity, it should be understood that various alterations and modifications could be made without departing from the scope of the invention as hereinafter claimed.

1. An apparatus for applying therapeutic spinal treatment to a patient, the apparatus having an axis and comprising:
an anchor adapted to connect to a first portion of the patient's body that is located axially above the cervical spine area in order to substantially fix the location of that first portion in the apparatus along three perpendicular axes so as to restrict movement of the first portion in at least five of the six directions along these three axes at least including all directions besides the “up” direction, and
a movable interface with which the patient is adapted to interact with an operative part of his body,
wherein the applying of the therapeutic spinal treatment includes movement of the movable interface together with the operative part of the patient's body in order to impose upon at least a second portion of the patient's body that is below the first portion movement at the spine.

2. The apparatus according to claim 1, wherein the movement of the movable interface is in a direction not along the axis, and wherein the movement at the spine is such that causes compression or tension in the spine.

3. The apparatus according to claims 1, wherein the apparatus comprises a base and the patient is adapted to bear upon the base with at least a portion of his weight and the therapeutic treatment includes axially displacing the base before having the movable interface move together with the operative part of the patient's body, and wherein the axial displacement of the base imposes upon the second portion of the body a movement at the spine that causes compression or tension in the spine.

4. The apparatus according to claim 3, wherein the movement of the movable interface is in a direction not along the axis.

5. The apparatus according to claim 4, wherein the movement at the spine due to the movement of the movable interface is such that is adapted to cause compression or tension at the spine.

6. The apparatus according to claim 4, wherein the movement at the spine due to the movement of the movable interface is such that is adapted to cause twisting of the spine.

7. The apparatus according to claim 6, wherein the twisting of the spine is generally about the axis of the apparatus.

8. The apparatus according to claim 6, wherein the twisting of the spine is generally about an axis transverse to the axis of the apparatus.

9. The apparatus according to claim 2, wherein the patient at the operative part of his body is adapted to bear upon the movable interface with at least a portion of his weight.

10. The apparatus according to claims 3 and comprising a resistance element that is adapted to resist the movement of the movable interface so that the movement of the movable interface is accomplished by the patient applying force above a certain threshold upon the movable interface via the operative part of his body.

11. The apparatus according to claim 9 and comprising a resistance element that is adapted to resist the movement of the movable interface so that the movement of the movable interface is accomplished by the patient applying force above a certain threshold upon the movable interface via the operative part of his body

12. The apparatus according to claims 3, wherein the movement of the movable interface is urged by the apparatus.

13. The apparatus according to claim 9, wherein the movement of the movable interface is urged by the apparatus.

14. The apparatus according to claim 3 and comprising a safety mechanism coupled to the anchor, wherein the movement at the second portion of the patient's body urges the first portion of the patient's body to apply a force upon the anchor, and wherein above a threshold force that is applied upon the anchor the safety mechanism is adapted to release the anchor from its fixed location in the apparatus.

15. The apparatus according to claim 9 and comprising a safety mechanism coupled to the anchor, wherein the movement at the second portion of the patient's body urges the first portion of the patient's body to apply a force upon the anchor, and wherein above a threshold force that is applied upon the anchor the safety mechanism is adapted to release the anchor from its fixed location in the apparatus.

16. The apparatus of claim 1, wherein the anchor includes a chin retaining portion and a back of the head retaining portion, the chin retaining portion and the back of the head retaining portion are adaptable to be movable so as to adjust a distance between the chin retaining portion and the back of the head retaining portion.

17. The apparatus of claim 13, further comprising a left and right zygomatic bone retaining portions adaptable to be movable so as to adjust a distance between the left and right zygomatic bone retaining portions.

18. The apparatus of claim 16, further comprising a zygomatic bone retaining portion to restrain side to side and rotational movement of the head.

19. The apparatus of claim 1, wherein the anchor includes a chin retaining portion and a rear-and-top-of-the-head retaining portion, the rear-and-top-of-the-head retaining portion retaining a back of the head and a top of the head.

20. The apparatus of claim 1, wherein the first portion of the patient's body is a head of the patient and wherein the anchor includes a first anchor portion that restrains a front of the head and a second anchor portion that restrains a back of the head.

21. A method for applying therapeutic spinal treatment to a patient comprising the steps of:
providing an apparatus comprising an anchor that is adapted to substantially fix in the apparatus the location along three perpendicular axes of a first portion of the patient's standing or sitting body that is located axially above the cervical spine area so as to restrict movement of the first portion in at least five of the six directions along these three axes at least including all directions besides the “up” direction, and a movable interface with which the patient is adapted to interact with an operative part of his body, and
having the movable interface move together with the operative part of the patient's body in order to impose upon at least a second portion of the patient's body that is below the first portion movement at the spine.

22. The method according to claim 21, wherein the movement of the movable interface is in a direction not along the axis, and wherein the movement at the spine is such that causes compression or tension in the spine.

23. The method according to claim 21, wherein the apparatus comprises in addition a base and the patient is adapted to bear upon the base with at least a portion of his weight and the therapeutic treatment includes axially displacing the base before having the movable interface move together with the operative part of the patient's body, and wherein the axial displacement of the base imposes upon the second portion of the body a movement at the spine that causes compression or tension in the spine.

24. The method according to claim 23, wherein the movement of the movable interface is in a direction not along the axis.

25. The method according to claim 24, wherein the movement at the spine due to the movement of the movable interface is such that is adapted to cause compression or tension at the spine.

26. The method according to claim 24, wherein the movement at the spine due to the movement of the movable interface is such that is adapted to cause twisting of the spine.

27. The method according to claim 26 wherein the twisting of the spine is generally about the axis of the apparatus.

28. The method according to claim 26 wherein the twisting of the spine is generally about an axis transverse to the axis of the apparatus.

29. A method of spine rehabilitation for a patient, comprising:
choosing a starting position of the patient in the treatment process, the starting position including one of a standing position and a sitting position;
stabilizing the patient by immobilizing one of (i) the head of the patient and (ii) the head and the axilla of the patient, the immobilizing of the head being along three perpendicular axes in at least five of the six directions along these three axes at least including all directions besides the “up” direction;
choosing a spine load from between unloading and loading;
choosing a motion module by choosing which movement the patient is to perform and a range of the movement; and
activating the patient with at least one of passive, assisted active, active and resisted movements.

30. The apparatus of claim 1, wherein the patient's body is standing or sitting.

31. The apparatus of claim 1, wherein the anchor restrains the first portion rotationally along each of the three axes.

32. The apparatus of claim 31, wherein the at least five of the six directions includes all six directions.

33. The method of claim 21, further comprising providing the apparatus with the anchor so that the anchor is also adapted to restrain the first portion rotationally along each of the three axes.

34. The method of claim, wherein the at least five of the six directions includes all six directions.

35. The method of claim 29, further comprising restraining the head rotationally along the three axes.

36. The method of claim 35, wherein the at least five of the six directions includes all six directions.

37. The apparatus of claim 3, wherein the base is adapted to rotate about an “X” axis, the “X” axis defining opposing axial upward and downward directions.

38. The apparatus of claim 1, wherein the at least five of the six directions includes all six directions.

39. The method of claim 21, wherein the at least five of the six directions includes all six directions.

40. The method of claim 29, wherein the at least five of the six directions includes all six directions.
